(19) United States
(12) Patent Application Publication
(10) Pub. No.: US 2026/0234876 A1
(43) Pub. Date: Aug. 13, 2026

(54) SYSTEM AND METHOD FOR ANALYZING WORK SURFACE OPERATED UPON BY MILLING MACHINE

(71) Applicant: Caterpillar Paving Products Inc., Brooklyn Park, MN (US)

(72) Inventors: Nathan Mashek, Albertville, MN (US); John Lee Marsolek, Watertown, MN (US); Eric Steven Engelmann, Delano, MN (US); Nathaniel S. Doy, Clayton, NC (US)

(73) Assignee: Caterpillar Paving Products Inc., Brooklyn Park, MN (US)

(21) Appl. No.: 19/050,476

(22) Filed: Feb. 11, 2025

(51) Int. Cl. E01C 23/01; E01C 23/088

(52) U.S. Cl. CPC E01C 23/01; E01C 23/088

(57) ABSTRACT

A system for analyzing a work surface operated upon by a milling machine includes an apparatus including one or more sensors. The one or more sensors scan the work surface after a work operation is performed on the work surface by the milling machine and configured to generate at least one input parameter indicative of one or more surface characteristics of the work surface. The system also includes a controller including a processor and a memory. The processor is configured to receive the at least one input parameter indicative of the one or more surface characteristics of the work surface from the one or more sensors. The processor is also configured to analyze the at least one input parameter to determine a smoothness of the work surface. The processor is further configured to generate an output signal indicative of the smoothness of the work surface.

### TECHNICAL FIELD

The present disclosure relates to a system for analyzing a work surface operated upon by a milling machine and a method for analyzing the work surface operated upon by the milling machine.

### BACKGROUND

A work machine, such as a milling machine, may be used to remove, mix, or reclaim material from various work surfaces, such as roads, streets, highways, and aircraft runways. The milling machine may include a cold planar, a surface miner, an asphalt milling machine, a pavement milling machine, a road grinder, a surface milling machine, and the like. The milling machine generally includes a rotary work tool disposed within a milling enclosure. The rotary work tool may be a rotor that is movable and in contact with a work surface to cut away a layer of the work surface.

The milling machine produces a surface texture after operating on the work surface. Typically, the surface texture may be used to determine a number of useful indicators related to an ongoing work operation and/or the milling machine. For example, the surface texture may provide an indication of maintenance requirements of the milling machine, broken or worn-out cutting tools, a high milling speed of the milling machine, and/or a low speed of the milling machine. Conventionally, the surface texture is determined or observed visually by an operator/user of the milling machine. Such a conventional method may be prone to errors and inconsistencies due to human involvement, especially under adverse conditions.

U.S. Pat. No. 11,834,797 describes a paving machine that can include a frame; a screed coupled to the frame; a plurality of sensors to scan a surface of an asphalt mat behind the screed; and a controller coupled to the plurality of sensors, the controller configured to determine a smoothness of the asphalt mat and to make changes to one or more paving characteristics of the paving machine to improve the smoothness of the asphalt mat.

### SUMMARY OF THE DISCLOSURE

In an aspect of the present disclosure, a system for analyzing a work surface operated upon by a milling machine is provided. The system includes an apparatus including one or more sensors. The one or more sensors scan the work surface after a work operation is performed on the work surface by the milling machine. The one or more sensors are configured to generate at least one input parameter indicative of one or more surface characteristics of the work surface after the work operation is performed on the work surface. The system also includes a controller including a processor and a memory. The processor is communicably coupled with the memory and the one or more sensors. The processor is configured to receive the at least one input parameter indicative of the one or more surface characteristics of the work surface from the one or more sensors. The processor is also configured to analyze the at least one input parameter to determine a smoothness of the work surface. The processor is further configured to generate an output signal indicative of the smoothness of the work surface.

In another aspect of the present disclosure, a method for analyzing a work surface operated upon by a milling machine is provided. The method includes providing an apparatus including one or more sensors. The method also includes scanning, by the one or more sensors, the work surface after a work operation is performed on the work surface by the milling machine. The method further includes generating, by the one or more sensors, at least one input parameter indicative of one or more surface characteristics of the work surface after the work operation is performed on the work surface. The method includes receiving, by a processor of a controller, the at least one input parameter indicative of the one or more surface characteristics of the work surface from the one or more sensors. The processor is communicably coupled with a memory of the controller and the one or more sensors. The method also includes analyzing, by the processor, the at least one input parameter to determine a smoothness of the work surface. The method further includes generating, by the processor, an output signal indicative of the smoothness of the work surface.

Other features and aspects of this disclosure will be apparent from the following description and the accompanying drawings.

### BRIEF DESCRIPTION OF THE DRAWINGS

FIG. 1 is a schematic perspective view of a milling machine, according to an example of the present disclosure;

FIG. 2 is a block diagram of a system for analyzing a work surface operated upon by the milling machine of FIG. 1, according to an example of the present disclosure;

FIG. 3 is a schematic view of a deviation of the work surface at one or more portions of the work surface, according to an example of the present disclosure;

FIG. 4 is a schematic view of an output image displayed to a user of the milling machine of FIG. 1, according to an example of the present disclosure; and

FIG. 5 is a flowchart of a method for analyzing the work surface operated upon by the milling machine of FIG. 1, according to an example of the present disclosure;

### DETAILED DESCRIPTION

Wherever possible, the same reference numbers will be used throughout the drawings to refer to the same or like parts.

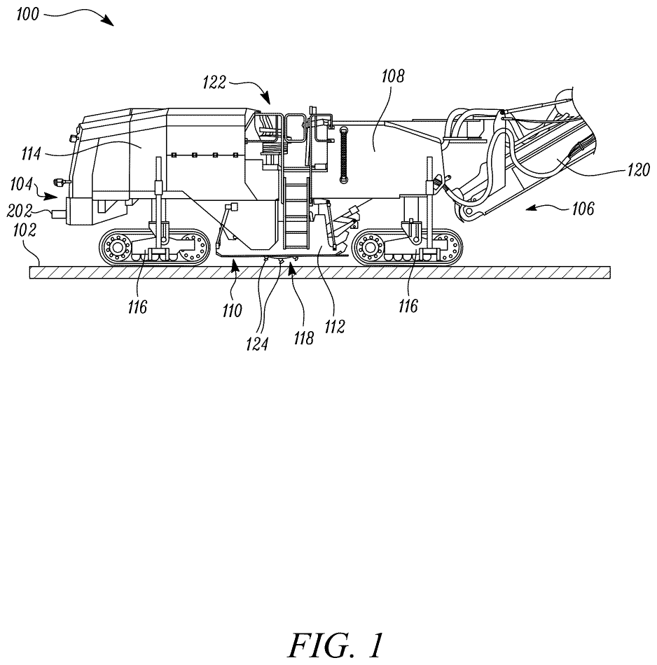

Referring to FIG. 1, a schematic perspective view of a milling machine 100 is illustrated. The milling machine 100 is a cold planar herein. The milling machine 100 may include an asphalt milling machine, a pavement profiler, a road milling machine, a roadway planer, a rotary mixer, or any other suitable machine that may be used to scarify, remove, mix, or reclaim material from a work surface 102. The work surface 102 may be made of bituminous material, concrete, and the like.

The milling machine 100 defines a rear end 104 and a front end 106 opposite to the rear end 104. The milling machine 100 includes a frame 108. The frame 108 supports various machine components thereon. The milling machine 100 further includes a milling enclosure 110 supported by the frame 108. The milling enclosure 110 includes one or more side plates 112. The milling enclosure 110 includes two side plates 112 (only one of the side plate 112 is shown for illustrative purposes) that are spaced apart from each other and disposed on either sides of the milling machine 100. The milling enclosure 110 is an enclosed space defined by the side plates 112, a front wall (not shown), and a rear wall (not shown).

The milling machine 100 further includes a power source (not shown) that generates power. The power source may be an engine, such as, an internal combustion engine (e.g., a compression ignition diesel engine), a gas turbine engine, a battery system, a fuel cell, and the like. The power source is mounted on the frame 108. The power source is enclosed within an enclosure 114. The milling machine 100 also includes two pairs of ground engaging members 116 (only one of each of the pairs of ground engaging members 116 are visible, the others are hidden from view). Each ground engaging member 116 is a track herein. Alternatively, the milling machine 100 may include wheels instead of tracks.

The milling machine 100 also includes a rotor 118 for milling the work surface 102. In one example, the rotor 118 may be a height adjustable rotor. The rotor 118 may include a rotatable drum (or a cylinder) and one or more cutting tools 124 disposed on the rotatable drum. The rotor 118 extends between the side plates 112. According to a need of the application, the rotor 118 may be lowered so that the rotor 118 may contact and cut the work surface 102 through forces applied by the one or more cutting tools 124 on the work surface 102.

The milling machine 100 further includes a discharge conveyor 120 disposed at the front end 106. Material removed from the work surface 102 may enter the discharge conveyor 120 which, for example, may then transfer the removed material into a dump truck (not shown) or other suitable machine for transportation off site.

The milling machine 100 further includes an operator station 122 supported by the frame 108. An operator of the milling machine 100 may sit or stand in the operator station 122 to overlook machine operations. The operator station 122 may also include different control devices that may be used for controlling one or more machine operations of the milling machine 100. The different control devices may include, but are not limited to, pedals, levers, switches, buttons, wheels, and other such devices as are known in the art.

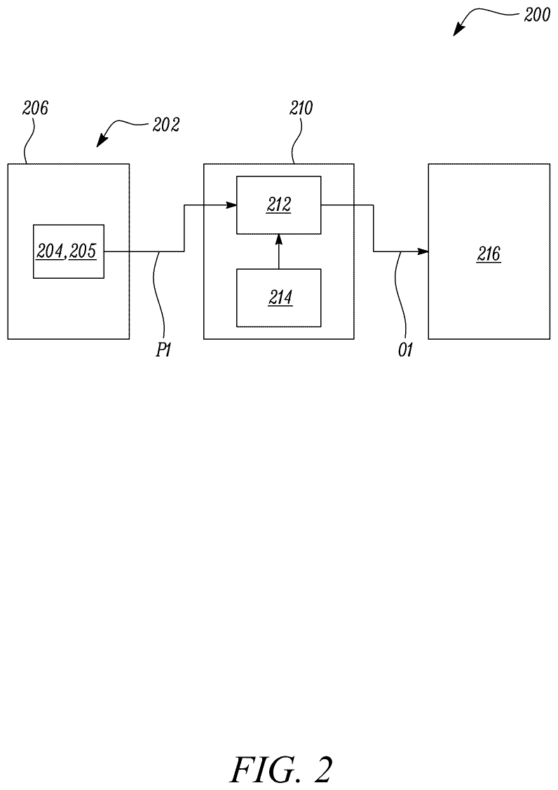

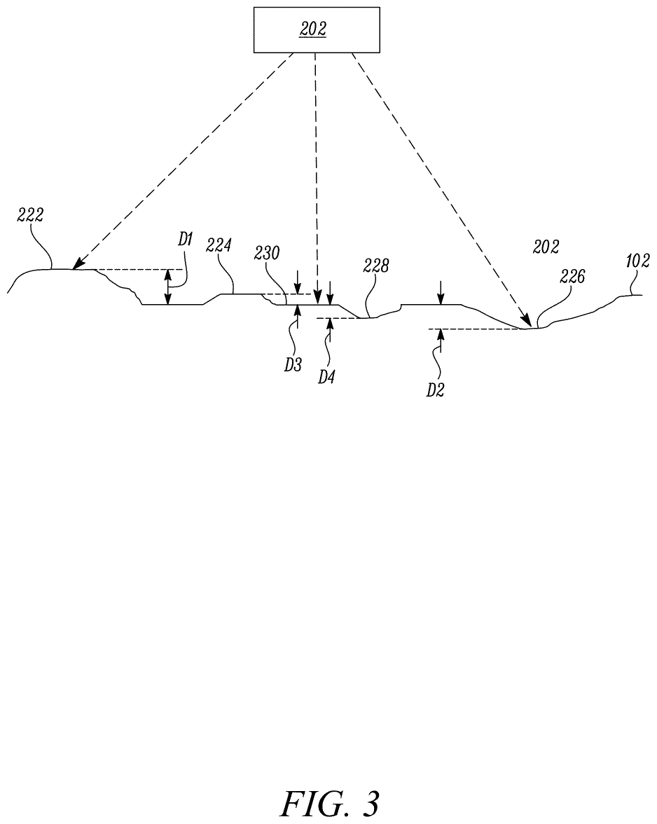

Referring to FIG. 2, a system 200 for analyzing the work surface 102 (see FIGS. 1 and 3) operated upon by the milling machine 100 (see FIG. 1) is illustrated. The milling machine 100 includes the system 200 for analyzing the work surface 102 operated upon by the milling machine 100. The system 200 includes an apparatus 202. The apparatus 202 is mounted on the milling machine 100 and/or the apparatus 202 is a handheld apparatus present with the operator of the milling machine 100. In some examples, the apparatus 202 may be a portable device that can be mounted on the milling machine 100 and can be easily removed to be handheld by the operator whenever needed.

The apparatus 202 includes a housing 206. The housing 206 may be made of a metallic material, a polymeric material, a ceramic material, and the like. When the apparatus 202 is mounted to the milling machine 100, the housing 206 may include suitable mounting provisions, such as brackets, fasteners, and so on. Further, when the apparatus 202 is the handheld apparatus, the housing 206 may include a suitable holding means to allow easy handling.

The apparatus 202 also includes one or more sensors 204, 205. The one or more sensors 204, 205 are disposed within the housing 206 of the apparatus 202. In some examples, the one or more sensors 204, 205 includes two or more sensors 204, 205. In the illustrated example of FIG. 2, the apparatus 202 includes two sensors 204, 205. Alternatively, the apparatus 202 may include a single sensor, or more than two sensors. The two or more sensors 204, 205 may be of a same type or of different types.

The one or more sensors 204, 205 include a light detection and ranging (LIDAR) sensor, a radio detection and ranging (RADAR) sensor, a camera, a sonic sensor, a sonar sensor, and/or an infrared sensor. The present disclosure is not limited by a type of the sensor 204, 205.

The one or more sensors 204, 205 scan the work surface 102 after a work operation is performed on the work surface 102 by the milling machine 100. Further, the one or more sensors 204, 205 generate one or more input parameters P1 indicative of one or more surface characteristics of the work surface 102 after the work operation is performed on the work surface 102. The one or more surface characteristics of the work surface 102 include a surface texture of the work surface 102, a topography of the work surface 102, a deviation of the work surface 102 at one or more portions 222, 224, 226, 228 (shown in FIG. 3) of the work surface 102 from a planar section 230 (shown in FIG. 3) of the work surface 102, a milling pattern generated on the work surface 102 after the work operation, and/or a distance value between the work surface 102 and the one or more sensors 204, 205. In some examples, the one or more surface characteristics of the work surface 102 may include a waviness of the work surface 102, a roughness of the work surface 102, a surface finish of the work surface 102, and the like, without limiting the scope of the present disclosure. The present disclosure is not limited by a type of the input parameters P1.

As shown in FIG. 3, the deviation of the work surface 102 at the one or more portions 222, 224, 226, 228 of the work surface 102 from the planar section 230 of the work surface 102 includes a maximum distance D1, D2 at the portion 222, 226 of the work surface 102 from the planar section 230 of the work surface 102 and/or a minimum distance D3, D4 at the portion 224, 228 of the work surface 102 from the planar section 230 of the work surface 102. Specifically, the maximum distance D1 is a maximum above ground distance from the planar section 230 to the portion 222, the maximum distance D2 is a maximum below ground distance from the planar section 230 to the portion 226, the minimum distance D3 is a minimum above ground distance from the planar section 230 to the portion 224, and the minimum distance D4 is a maximum below ground distance from the planar section 230 to the portion 228.

Referring again to FIG. 2, the system 200 also includes a controller 210. The controller 210 may include a machine control module present onboard the milling machine 100. Alternatively, the controller 210 may be inbuilt with the apparatus 202. The controller 210 includes a memory 214. The memory 214 may include any means of storing information, including a hard disk, an optical disk, a floppy disk, read only memory (ROM), random access memory (RAM), programmable ROM (PROM), electrically erasable PROM (EEPROM), or other computer-readable memory media.

The controller 210 also includes a processor 212 communicably coupled with the memory 214 and the one or more sensors 204, 205. It should be noted that the processor 212 may include a single microprocessor or multiple microprocessors for receiving various input signals and generating output signals. Numerous commercially available microprocessors may perform the functions of the processor 212. The processor 212 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The processor 212 may include one or more components that may be operable to execute computer executable instructions or computer code that may be stored and retrieved from the memory 214.

The processor 212 receives the one or more input parameters P1 indicative of the one or more surface characteristics of the work surface 102 (see FIGS. 1 and 3) from the one or more sensors 204, 205. The processor 212 analyzes the one or more input parameters P1 to determine a smoothness of the work surface 102. Further, the processor 212 generates an output signal O1 indicative of the smoothness of the work surface 102.

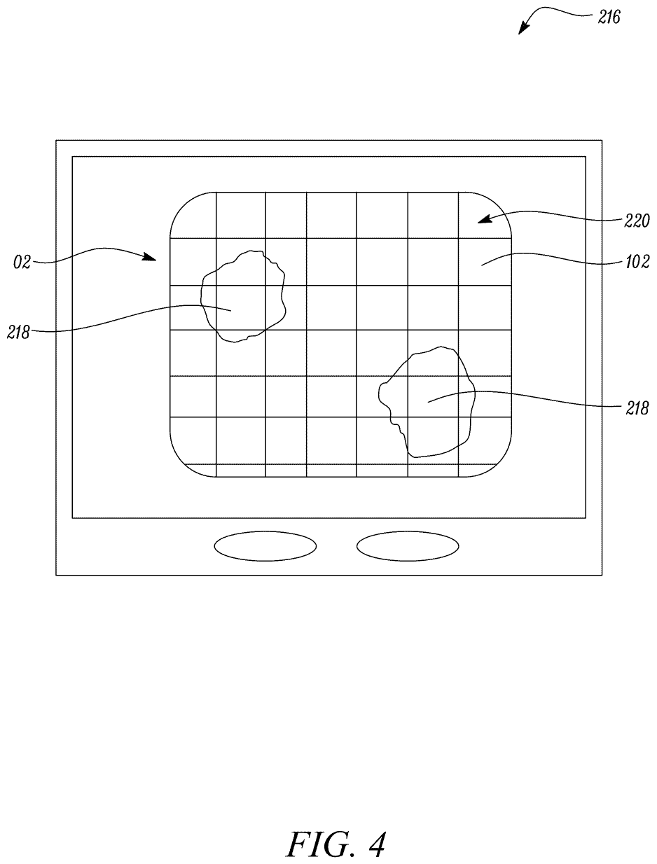

Referring to FIGS. 2 and 4, the system 200 further includes an output device 216 communicably coupled with the processor 212. The output device 216 may be disposed within the operator station 122 (see FIG. 1) of the milling machine 100. Alternatively, the output device 216 may be disposed outside of the operator station 122. In an example, when the apparatus 202 is handheld, the output device 216 may be inbuilt with the apparatus 202. The output device 216 may include any Input/Output device, such as a display screen, a tablet, a smartphone, and so on.

The output device 216 receives the output signal O1 indicative of the smoothness of the work surface 102 from the processor 212. The output device 216 displays an output image O2 indicative of the smoothness of the work surface 102 based on a receipt of the output signal O1.

The output image O2 includes a virtual representation 220 of the work surface 102 and one or more visual indicators 218 overlayed on the work surface 102. The one or more visual indicators 218 are indicative of variation in smoothness at the one or more portions 222, 224, 226, 228 (see FIG. 3) of the work surface 102. Further, the one or more visual indicators 218 are indicative of a deviation in one or more operational parameters of the milling machine 100 and/or one or more maintenance parameters of the milling machine 100. Specifically, the details provided by the output image O2 may be correlated to operation and/or maintenance parameters of the milling machine 100.

Furthermore, the one or more surface characteristics of the work surface 102 are based on a condition of the one or more cutting tools 124 (see FIG. 1) associated with the milling machine 100, an operation of the milling machine 100 and/or the rotor 118 (see FIG. 1) at a high speed while performing the work operation, and/or an operation of the milling machine 100 and/or the rotor 118 at a low speed while performing the work operation. In other words, the condition of the one or more cutting tools 124 and a speed of milling machine 100 and/or the rotor 118 may impact the surface characteristics, such as the milling pattern generated on the work surface 102, and the surface characteristics of the work surface 102 may vary based on the condition of the one or more cutting tools 124 and the speed of milling machine 100 and/or the rotor 118. Thus, the one or more visual indicators 218 are indicative of the condition of the one or more cutting tools 124 associated with the milling machine 100, the operation of the milling machine 100 and/or the rotor 118 at the high speed while performing the work operation, and/or the operation of the milling machine 100 and/or the rotor 118 at the low speed while performing the work operation. It should be noted that the output image O2 is exemplary in nature, and the output image O2 may include any other data to indicate the smoothness of the work surface 102.

It should be noted that any other parameter related to the milling machine 100 and/or the work operation may impact the surface characteristics of the work surface 102, without any limitations.

It is to be understood that individual features shown or described for one example may be combined with individual features shown or described for another example. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the system 200 for analyzing the work surface 102 operated upon by the milling machine 100. The system 200 includes the apparatus 202 mounted on the milling machine 100 and/or handheld by the operator of the milling machine 100. As the apparatus 202 can be mounted on the milling machine 100 and/or may be handheld, the apparatus 202 may provide customizable work positions and/or improved flexibility in usage of the apparatus 202.

Further, the system 200 includes the one or more sensors 204, 205 to scan the work surface 102 after the work operation and to generate the one or more input parameters P1 indicative of the one or more surface characteristics of the work surface 102. The system 200 may include a single sensor or more than one sensor. For example, usage of the two sensors 204, 205 may increase system reliability and accuracy. The one or more sensors 204, 205 may reduce errors while determining the one or more surface characteristics of the work surface 102 after the work operation is performed by milling machine 100, as it involves minimal human involvement. Further, the apparatus 202 may be usable under adverse conditions, for example, when it is not possible for users to manually inspect the work surface 102.

The system 200 also includes the controller 210 including the processor 212 that receives the one or more input parameters P1 indicative of the one or more surface characteristics of the work surface 102 from the one or more sensors 204, 205 and generates the output signal O1. The system 200 further includes the output device 216 that receives the output signal O1 and displays the output image O2 indicative of the smoothness of the work surface 102.

Moreover, the output image O2 includes the one or more visual indicators 218 which may indicate variation in the smoothness of the work surface 102, the deviation in operational parameters of the milling machine 100, the deviation in maintenance parameters of the milling machine 100, the condition of the one or more cutting tools 124 associated with the milling machine 100, the operation of the milling machine 100 at the high speed while performing the work operation, the operation of the milling machine 100 at the low speed while performing the work operation, and so on. The one or more visual indicators 218 may coach the operator of the milling machine 100 regarding an optimal/desired speed of the milling machine 100 and/or the rotor 118 to improve the work operation being performed. Indications provided by the system 200 may reduce downtime of the milling machine 100 and may improve productivity by alerting operators/users regarding any inconsistencies in the milling machine 100 or the operation of the milling machine 100.

Overall, the system 200 is simple in operation and does not require complex components for manufacturing. Further, the system 200 may improve operating time and an efficiency of the milling machine 100. Furthermore, the system 200 may be reliable in operation, may be cost-effective, may be retrofitted on existing milling machines, and may be easy to install on milling machines.

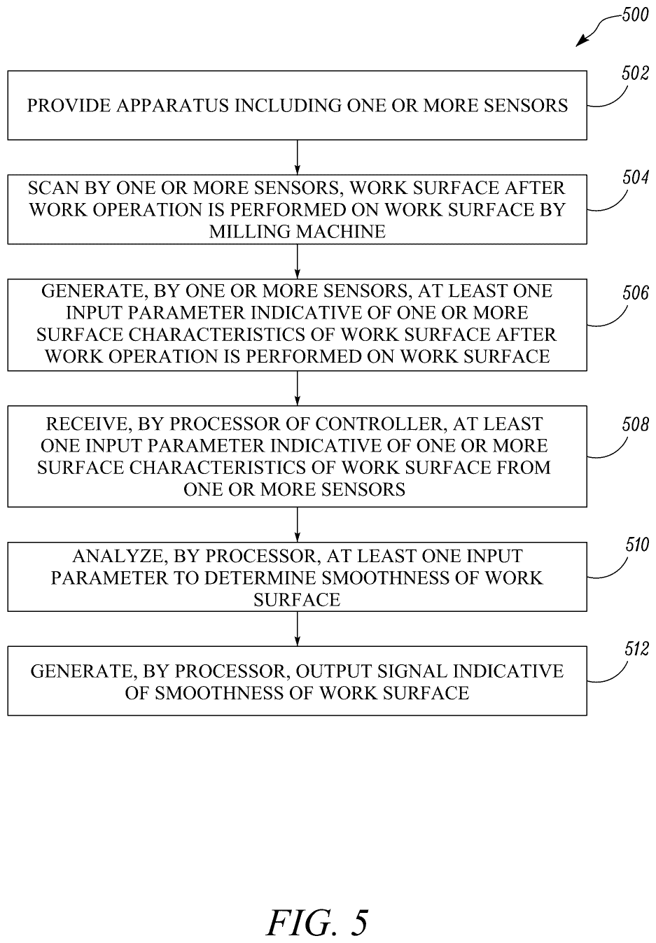

FIG. 5 is a flowchart for a method 500 for analyzing the work surface 102 operated upon by the milling machine 100. With reference to FIGS. 1 to 5, at step 502, the apparatus 202 including the one or more sensors 204, 205 is provided. The apparatus 202 is mounted on the milling machine 100 and/or the apparatus 202 is held by the operator of the milling machine 100. The one or more sensors 204, 205 include the LIDAR sensor, the RADAR sensor, the camera, the sonic sensor, the sonar sensor, and/or the infrared sensor.

At step 504, the one or more sensors 204, 205 scan the work surface 102 after the work operation is performed on the work surface 102 by the milling machine 100.

At step 506, the one or more sensors 204, 205 generate the one or more input parameters P1 indicative of the one or more surface characteristics of the work surface 102 after the work operation is performed on the work surface 102. The one or more surface characteristics of the work surface 102 includes the surface texture of the work surface 102, the topography of the work surface 102, the deviation of the work surface 102 at the one or more portions 222, 224, 226, 228 of the work surface 102 from the planar section 230 of the work surface 102, the milling pattern generated on the work surface 102 after the work operation, and/or the distance value between the work surface 102 and the one or more sensors 204, 205.

The deviation of the work surface 102 at the one or more portions 222, 224, 226, 228 of the work surface 102 from the planar section 230 of the work surface 102 includes the maximum distance D1, D2 at the portion 222, 226 of the work surface 102 from the planar section 230 of the work surface 102 and/or the minimum distance D3, D4 at the portion 224, 228 of the work surface 102 from the planar section 230 of the work surface 102.

At step 508, the processor 212 of the controller 210 receives the one or more input parameters P1 indicative of the one or more surface characteristics of the work surface 102 from the one or more sensors 204, 205. The processor 212 is communicably coupled with the memory 214 of the controller 210 and the one or more sensors 204, 205.

At step 510, the processor 212 analyzes the one or more input parameters P1 to determine the smoothness of the work surface 102.

At step 512, the processor 212 generates the output signal O1 indicative of the smoothness of the work surface 102.

The output device 216 is communicably coupled with the processor 212. The method 500 further includes a step (not shown) at which the output device 216 receives the output signal O1 from the processor 212 indicative of the smoothness of the work surface 102. The method 500 further includes a step (not shown) at which the output device 216 displays the output image O2 indicative of the smoothness of the work surface 102 based on the receipt of the output signal O1.

The output image O2 includes the virtual representation 220 of the work surface 102 and the one or more visual indicators 218 overlayed on the work surface 102. The method 500 further includes a step (not shown) at which the variation in smoothness is indicated at the one or more portions 222, 224, 226, 228 of the work surface 102 based on the one or more visual indicators 218 associated with the output image O2.

The method 500 further includes a step (not shown) at which the deviation of the one or more operational parameters of the milling machine 100 and/or the one or more maintenance parameters of the milling machine 100 is indicated based on the one or more visual indicators 218 associated with the output image O2.

The one or more surface characteristics of the work surface 102 are based on the condition of the one or more cutting tools 124 associated with the milling machine 100, the operation of the milling machine 100 and/or the rotor 118 at the high speed while performing the work operation, and/or the operation of the milling machine 100 and/or the rotor 118 at the low speed while performing the work operation. The method 500 further includes a step (not shown) at which the condition of the one or more cutting tools 124 associated with the milling machine 100, the operation of the milling machine 100 and/or the rotor 118 at the high speed while performing the work operation, and/or the operation of the milling machine 100 and/or the rotor 118 at the low speed while performing the work operation is indicated based on the one or more visual indicators 218 associated with the output image O2.

It should be noted that the steps 502, 504, 506, 508, 510, 512 of the method 500 may be performed in a sequence that is different from that explained in relation to FIG. 5. Further, various steps 502, 504, 506, 508, 510, 512 can be performed together.

While aspects of the present disclosure have been particularly shown and described with reference to the examples above, it will be understood by those skilled in the art that various additional examples may be contemplated by the modification of the disclosed work machine, systems, and methods without departing from the spirit and scope of the disclosure. Such examples should be understood to fall within the scope of the present disclosure as determined based upon the claims and any equivalents thereof.

1. A system for analyzing a work surface operated upon by a milling machine, the system comprising:
an apparatus including one or more sensors, wherein the one or more sensors scan the work surface after a work operation is performed on the work surface by the milling machine, and wherein the one or more sensors are configured to generate at least one input parameter indicative of one or more surface characteristics of the work surface after the work operation is performed on the work surface; and
a controller including a processor and a memory, wherein the processor is communicably coupled with the memory and the one or more sensors, and wherein the processor is configured to:
receive the at least one input parameter indicative of the one or more surface characteristics of the work surface from the one or more sensors;
analyze the at least one input parameter to determine a smoothness of the work surface; and
generate an output signal indicative of the smoothness of the work surface.

2. The system of claim 1, wherein the one or more surface characteristics of the work surface includes at least one of a surface texture of the work surface, a topography of the work surface, a deviation of the work surface at one or more portions of the work surface from a planar section of the work surface, a milling pattern generated on the work surface after the work operation, and a distance value between the work surface and the one or more sensors.

3. The system of claim 2, wherein the deviation of the work surface at the one or more portions of the work surface from the planar section of the work surface includes a maximum distance at a portion of the work surface from the planar section of the work surface and/or a minimum distance at a portion of the work surface from the planar section of the work surface.

4. The system of claim 1, wherein the one or more sensors include at least one of a light detection and ranging (LIDAR) sensor, a radio detection and ranging (RADAR) sensor, a camera, a sonic sensor, a sonar sensor, and/or an infrared sensor.

5. The system of claim 1, wherein the apparatus includes a housing, and wherein the one or more sensors are disposed within the housing of the apparatus.

6. The system of claim 1, wherein the apparatus is mounted on the milling machine and/or the apparatus is a handheld apparatus present with an operator of the milling machine.

7. The system of claim 1, wherein the one or more sensors includes at least two sensors, and wherein the at least two sensors are of a same type or of different types.

8. The system of claim 1 further comprising an output device communicably coupled with the processor, wherein the output device is configured to receive the output signal indicative of the smoothness of the work surface from the processor, and wherein the output device is configured to display an output image indicative of the smoothness of the work surface based on a receipt of the output signal.

9. The system of claim 8, wherein the output image includes a virtual representation of the work surface and one or more visual indicators overlayed on the work surface, and wherein the one or more visual indicators are indicative of variation in smoothness at one or more portions of the work surface.

10. The system of claim 9, wherein the one or more visual indicators are indicative of a deviation in one or more operational parameters of the milling machine and/or one or more maintenance parameters of the milling machine.

11. The system of claim 9, wherein the one or more surface characteristics of the work surface are based on a condition of one or more cutting tools associated with the milling machine, an operation of the milling machine and/or a rotor of the milling machine at a high speed while performing the work operation, and/or an operation of the milling machine and/or the rotor at a low speed while performing the work operation, and wherein the one or more visual indicators are indicative of the condition of the one or more cutting tools, the operation of the milling machine and/or the rotor at the high speed while performing the work operation, and/or the operation of the milling machine and/or the rotor at the low speed while performing the work operation.

12. A method for analyzing a work surface operated upon by a milling machine, the method comprising:
providing an apparatus including one or more sensors;
scanning, by the one or more sensors, the work surface after a work operation is performed on the work surface by the milling machine;
generating, by the one or more sensors, at least one input parameter indicative of one or more surface characteristics of the work surface after the work operation is performed on the work surface;
receiving, by a processor of a controller, the at least one input parameter indicative of the one or more surface characteristics of the work surface from the one or more sensors, wherein the processor is communicably coupled with a memory of the controller and the one or more sensors;
analyzing, by the processor, the at least one input parameter to determine a smoothness of the work surface; and
generating, by the processor, an output signal indicative of the smoothness of the work surface.

13. The method of claim 12, wherein the one or more surface characteristics of the work surface includes at least one of a surface texture of the work surface, a topography of the work surface, a deviation of the work surface at one or more portions of the work surface from a planar section of the work surface, a milling pattern generated on the work surface after the work operation, and a distance value between the work surface and the one or more sensors.

14. The method of claim 13, wherein the deviation of the work surface at the one or more portions of the work surface from the planar section of the work surface includes a maximum distance at a portion of the work surface from the planar section of the work surface and/or a minimum distance at a portion of the work surface from the planar section of the work surface.

15. The method of claim 12, wherein the one or more sensors include at least one of a light detection and ranging (LIDAR) sensor, a radio detection and ranging (RADAR) sensor, a camera, a sonic sensor, a sonar sensor, and/or an infrared sensor.

16. The method of claim 12, wherein the step of providing the apparatus further includes:
mounting the apparatus on the milling machine; and/or
holding the apparatus by an operator of the milling machine.

17. The method of claim 12, wherein an output device is communicably coupled with the processor, the method further comprising:
receiving, by the output device, the output signal indicative of the smoothness of the work surface from the processor; and
displaying, by the output device, an output image indicative of the smoothness of the work surface based on a receipt of the output signal.

18. The method of claim 17, wherein the output image includes a virtual representation of the work surface and one or more visual indicators overlayed on the work surface, the method further comprising:
indicating a variation in smoothness at one or more portions of the work surface based on the one or more visual indicators associated with the output image.

19. The method of claim 18 further comprising:
indicating a deviation in one or more operational parameters of the milling machine and/or one or more maintenance parameters of the milling machine based on the one or more visual indicators associated with the output image.

20. The method of claim 18, wherein the one or more surface characteristics of the work surface are based on a condition of one or more cutting tools associated with the milling machine, an operation of the milling machine and/or a rotor of the milling machine at a high speed while performing the work operation, and/or an operation of the milling machine and/or the rotor at a low speed while performing the work operation, the method further comprising:
indicating the condition of the one or more cutting tools, the operation of the milling machine and/or the rotor at the high speed while performing the work operation, and/or the operation of the milling machine and/or the rotor at the low speed while performing the work operation based on the one or more visual indicators associated with the output image.
